(19) United States
(12) Patent Application Publication
(10) Pub. No.: US 2012/0123028 A1
(43) Pub. Date: May 17, 2012

(54) METHOD FOR PREPARING CROSSLINKED BITUMEN/POLYMER COMPOSITIONS WITHOUT USE OF A CROSSLINKING AGENT

(75) Inventors: Sylvia Dreesen, Solaize (FR); Julien Chaminand, Vaulx En Velin (FR); Jean-Pierre Mesnil, Puteaux (FR)

(73) Assignee: TOTAL RAFFINAGE MARKETING, Puteaux (FR)

(21) Appl. No.: 13/386,818

(22) PCT Filed: Jul. 28, 2010
(86) PCT No.: PCT/IB10/53420

§ 371 Date: Jan. 24, 2012

(30) Foreign Application Priority Data
Jul. 29, 2009 (FR) 09/03729

(51) Int. Cl. C08L 95/00

(52) U.S. Cl. 524/68

(57) ABSTRACT

The disclosure relates to a method for preparing crosslinked bitumen/polymer compositions without using any crosslinking agent, wherein at least one bitumen and at least one polymeric composition including at least 80% by mass with respect to the mass of the polymeric composition, of a diblock copolymer of a monovinylaromatic hydrocarbon block and of a conjugate diene block having a molecular mass greater than or equal to 80,000 g mol⁻¹ a content of 1-2 double bond units coming from the conjugate diene greater than or equal to 15% by mass with respect to the total mass of the conjugate diene units, are brought into contact, optionally with stirring, at a temperature between 180° C. and 220° C. for a period of 4 hours to 48 hours.

### CROSS-REFERENCE TO RELATED APPLICATIONS

This application is a National Phase Entry of International Application No. PCT/IB2010/053420, filed on Jul. 28, 2010, which claims priority to French Patent Application Serial No. 09/03729, filed on Jul. 29, 2009, both of which are incorporated by reference herein.

### TECHNICAL FIELD

The present invention relates to the field of bitumens, in particular to the field of bitumen/polymer compositions. This invention relates to a method for preparing crosslinked bitumen/polymer compositions without use of a crosslinking agent. The present invention also relates to crosslinked bitumen/polymer compositions that may be obtained by this method. The invention further relates to the use of a polymer for crosslinking, bitumen/polymer compositions without use of any crosslinking agent. The invention finally relates to a method for preparing crosslinked or uncrosslinked concentrated polymer stock solutions, said crosslinked or uncrosslinked concentrated stock solutions being then diluted with bitumen to provide crosslinked bitumen/polymer compositions.

### BACKGROUND

The use of bitumen in manufacturing materials for road and industrial applications has been known for a long time: bitumen is the main hydrocarbon binder used in the field of road construction or civil engineering. In order to be used as a binder in these various applications, bitumen must have certain chemical, physical and mechanical properties. It is well known that the properties of pure bitumen may be modified by the addition of polymers. Mention may be made for example of the addition of monovinylaromatic and conjugate diene copolymers, such as styrene and butadiene copolymers. It is also well known that resistance to mechanical and thermal stresses, and rheological, elastic, and mechanical performances of bitumen/polymer compositions are significantly improved when monovinylaromatic and conjugate diene polymers, such as styrene and butadiene copolymers, are crosslinked by using sulphur-based crosslinking agents.

During the preparation of bitumen/polymer compositions crosslinked with sulphur, the addition of sulphur may lead to emissions of sulphurized hydrogen (also called hydrogen sulphide or H₂S). Hydrogen sulphide is a colourless, very toxic gas, which in addition has a characteristic smell and this at very low concentrations. Emissions of hydrogen sulphide may therefore be bothersome, in particular for those persons who prepare crosslinked bitumen/polymer compositions using crosslinking agents based on sulphur. It would therefore be desirable, in particular for the comfort and safety of workers, to find an alternative method for preparing crosslinked bitumen/polymer compositions, without applying sulphur-based crosslinking agents.

Thus, application WO2007/058994 describes a method for preparing bitumen/polymer compositions without the use of a crosslinking agent. The method applies a temperature between 185° C. and 221° C. for 4 to 30 hours, at least one bitumen, and at least one composition of block polymers, comprising:
(i) a diblock copolymer comprising a monovinylaromatic hydrocarbon block and a conjugate diene block having a molecular mass between 30,000 and 78,000 and 35 to 80% vinyl content with respect to the amount of conjugate diene units,
(ii) possibly, one or more copolymer block comprising at least two monovinylaromatic blocks and at least one block of conjugate diene polymer being selected from linear triblock copolymers having a molecular mass that is 1.5 to 3 times that of the diblock copolymers (i), the branched copolymer blocks having a molecular mass that is 1.5 to 9 times that of the diblock copolymer (i), alone or as a mixture, each copolymer block having a 35 to 80% vinyl content with respect to the amount of conjugate diene units, the ratio between (i) and (ii) being greater than 1:1.

Application WO2008/137394, in turn, describes a method for preparing bitumen/polymer compositions without the use of a crosslinking agent. The method at a temperature of between 160° C. and 221° C. for 2 to 30 hours, applies at least one bitumen and at least one polymeric composition block comprising:

a copolymer block of formula B1-B2-S with
S being a monovinylaromatic hydrocarbon block having a molecular mass between 10,000 and 25,000,
B1 being a polybutadiene block with a vinyl content of less than 15%,
B2 being a polybutadiene block with a vinyl content above 25% and with a mass ratio between B1 and B2 equal to or greater than 1:1, the copolymer block S-B1-B2 having a molecular mass of 40,000 to 200 000, and

optionally one or more copolymer blocks of formula (S-B1-B2)ₙX with
S being a monovinylaromatic hydrocarbon block having a molecular mass between 10,000 and 25,000,
B1 being a polybutadiene block having a vinyl content of less than 15%,
B2 being a polybutadiene block having a vinyl content above 25%,
n being an integer from 2 to 6,
X being a residue of a coupling agent,
   the block copolymer (S-B1-B2)ₙX having a molecular mass from 1.5 to 6,0 times that of the block copolymer S-B1-B2 and the ratio between S-B1-B2 and (S-B1-B2)ₙX being greater than 1:1.

In patent EP0728814, bituminous compositions are described, comprising a bituminous component and a composition of styrene/butadiene block copolymer. The styrene/butadiene block copolymer composition has a vinyl content of at least 25% by weight with respect to the total butadiene content, a styrene butadiene diblock content of 25% by weight or less and any uncoupled styrene/butadiene diblock copolymer has a molecular weight which is within the range of 100,000 to 170,000. To prepare these bituminous compositions, the bituminous component and the block copolymer composition are heated to 180° C., with stirring, for 60 minutes. In the method of this patent, the bitumen/polymer compositions are therefore not crosslinked.

Also in patent EP0850277, bituminous compositions are described, comprising a bituminous component and a block copolymer composition. The block copolymer composition comprises at least one component selected from linear triblock copolymers, multibranched block copolymers and diblock copolymers based on styrene and butadiene, the vinyl content of the block copolymer composition being at least 25% by weight, with respect to the total diene content, and any uncoupled diblock copolymer having a molecular weight, ranging from 60,000 to 100,000. To prepare these bituminous compositions, the bituminous component, and the block copolymer composition are heated to 180° C., with stirring, for 60 minutes. In the method of this patent, the bitumen/polymer compositions are therefore not crosslinked.

Finally, patent EP0907686 of the applicant company describes a method for preparing crosslinked bitumen/polymer compositions comprising two steps. In a first step, an uncrosslinked bitumen/polymer composition is prepared at temperatures between 100° C. and 230° C., in particular at 175° C. and with stirring, for at least 10 minutes, usually in the order of several tens of minutes to several hours, in particular for 2.5 hours, by contact of a bitumen and a styrene/butadiene copolymer with a proportion of 1.2 double bond units from the butadiene comprised between 12% and 50% by weight of the said copolymer. In a second step, a crosslinking agent such as a sulphur donor coupling agent, is incorporated for crosslinking the uncrosslinked bitumen/polymer composition. This second step is performed at temperatures comprised between 100° C. and 230° C., in particular at 175° C. and with stirring, for at least 10 minutes, in particular for 3 hours, by bringing into contact the uncrosslinked bitumen/polymer composition obtained in the first step and of a sulphur donor coupling agent.

### SUMMARY

Under these circumstances, the purpose of this invention is to provide a novel crosslinking method without using a crosslinking agent, and with which may be obtained crosslinked bitumen/polymer compositions, having enhanced mechanical and rheological properties, in particular as regards their consistency and/or their thermal sensitivity, and/or their elastic recovery and/or their tensile properties and/or their cohesion and/or their rigidity according to the Superpave specifications and/or their storage stability. Other characteristics such as resistance to aging or to hydrocarbons, low temperature behaviour, may also be improved. Similarly, for asphaltic mixes obtained from the crosslinked bitumen/polymer compositions according to the invention, the goal of the invention is to improve their fatigue behaviour and/or their resistance to rutting and/or resistance to thermal cracking.

The applicant company has developed a novel method for crosslinking bitumen/polymer compositions without use of any crosslinking agent by applying, optionally with stirring, at a temperature comprised between 180° C. and 220° C. for a period of 4 hours to 48 hours, at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units coming from the conjugate diene, greater than or equal to 15% by mass, with respect to the total mass of the conjugate diene units.

### BRIEF DESCRIPTION

The invention relates to a method for preparing crosslinked bitumen/polymer compositions without using any crosslinking agent, wherein at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units coming from the conjugate diene, greater than or equal to 15% by mass, with respect to the total mass of the conjugate diene units, are brought into contact, optionally with stirring, at a temperature between 180° C. and 220° C. for 4 hours to 48 hours. Preferably, the diblock copolymer has a content of 1-2 double bond units coming from butadiene comprised between 15% and 30% by mass with respect to the total mass of conjugate diene units. Preferably, the molecular mass of the diblock copolymer is greater than or equal to 90,000 g mol ⁻¹, preferably greater than or equal to 100,000 g.mol ⁻¹, more preferably greater than or equal to 110,000 g.mol⁻¹, still more preferably greater than or equal to 120,000 g.mol⁻¹.

Preferably, the period of time or duration required is from 6 hours to 30 hours, preferably from 8 hours to 24 hours, more preferably from 10 hours to 20 hours, still more preferably from 12 hours to 16 hours. Preferably, the temperature is between 185° C. and 215° C., preferably between 190° C. and 210° C., still more preferably between 195° C. and 205° C. Preferably, the thereby obtained crosslinked bitumen/polymer composition has a maximum elongation, according to standard NF EN 13587, greater than or equal to 400%, preferably greater than or equal to 500%, more preferably greater than or equal to 600%, still more preferably greater than or equal to 700%.

Preferably, the thereby obtained crosslinked bitumen/polymer composition has a maximum elongation stress, according to standard NF EN 13587, greater than or equal to 0.4 MPa, preferably greater than or equal to 0.6 MPa, more preferably greater than or equal to 0.8 MPa, still more preferably greater than or equal to 1.2 MPa. Preferably, the thereby obtained crosslinked bitumen/polymer composition has a conventional energy at 400% elongation, according to standard NF EN 13587, greater than or equal to 3 J/cm², preferably greater than or equal to 5 J/cm², more preferably greater than or equal to 10 J/cm², still more preferably greater than or equal to 15 J/cm². Preferably, the monovinylaromatic hydrocarbon content of the diblock copolymer is comprised between 20% and 50% by mass with respect to the mass of the said copolymer.

Preferably, the diblock copolymer comprises a random hinge, the monovinylaromatic hydrocarbon content in the form of a block being comprised between 15% and 30% by mass with respect to the mass of the said copolymer and the monovinylaromatic hydrocarbon content in the random hinge being comprised between 5% and 20% by mass with respect to the mass of the said copolymer. Preferably, the monovinylaromatic hydrocarbon is styrene and the conjugate diene is butadiene. Preferably, the polymeric composition comprises at least 85% by mass of diblock copolymer with respect to the mass of the polymeric composition, preferably at least 90% by mass, more preferably at least 95% by mass, still more preferably at least 98% by mass. Preferably, the amount of polymeric composition comprises between 5% and 30% by mass with respect to the mass of the bitumen/polymer composition, preferably between 2% and 20%, more preferably between 5% and 10%.

The invention also relates to the crosslinked bitumen/polymer composition without any crosslinking agent that may be obtained by the method such as defined above. The invention further relates to the use of a polymeric composition comprising at least 80% by mass with respect to the mass of the polymeric composition of a diblock copolymer of a monovinylaromatic hydrocarbon block and of a conjugate diene block having a molecular mass greater than or equal to 80,000 g.mol⁻¹ and a content of 1-2 double bond units coming from the conjugate diene, greater than or equal to 15% by mass with respect to the total mass of the conjugate diene units in bitumen without the need to use a crosslinking agent for crosslinking said bitumen/polymer composition. The invention further provides a method for preparing a crosslinked stock solution without the use of a crosslinking agent, wherein at least one oil, optionally at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units coming from the conjugate diene, greater than or equal to 15% by mass with respect to the total mass of the conjugate diene units, are brought into contact, optionally with stirring at a temperature between 180° C. and 220° C. for a period of 4 hours to 48 hours. Preferably, the method of preparing a crosslinked stock solution without the use of a crosslinking agent has the duration and temperature characteristics defined above for the method for preparing crosslinked bitumen/polymer compositions without the use of a crosslinking agent.

The invention further provides a method for preparing an uncrosslinked stock solution, wherein at least one oil, optionally at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units coming from the conjugate diene, greater than or equal to 15% by mass with respect to the total mass of the conjugate diene units, are brought into contact, optionally with stirring at a temperature between 120° C. and 160° C. for a period from 15 minutes to 4 hours. Preferably, the oil is an oil originating from petroleum or from plants. Preferably, the method for preparing a crosslinked or uncrosslinked stock solution makes use of a diblock copolymer that has the characteristics defined above, in terms of a content of 1-2 double bond units coming from the conjugate diene, of molecular mass, of monovinylaromatic hydrocarbon content, of monovinylaromatic hydrocarbon content in the presence of a random hinge, of chemical nature of the monovinylaromatic hydrocarbon and of the conjugate diene.

Preferably, the polymeric composition used in the method of preparing a crosslinked or uncrosslinked stock solution comprises at least 85% by mass of diblock copolymer with respect to the mass of the polymeric composition, preferably at least 90% by mass, more preferably at least 95% by mass, still more preferably at least 98% by mass. Preferably, the amount of polymeric composition used in the method of preparing a crosslinked or uncrosslinked stock solution is between 5% and 50% by mass with respect to the mass of stock solution, preferably between 10% and 40%, more preferably between 20% and 30%.

The invention also relates to a crosslinked stock solution without any crosslinking agent, which may be obtained by the preparation method as defined above. The invention also relates to an uncrosslinked stock solution, which may be obtained by the preparation method as defined above.

The invention also relates to a method for preparing crosslinked bitumen/polymer compositions without using any crosslinking agent by diluting the crosslinked stock solution without any crosslinking agent as defined above, in at least a single bitumen at a temperature comprised between 160° C. and 220° C., optionally with stirring, for a period of 15 minutes to 4 hours. The invention also relates to a method for preparing crosslinked bitumen/polymer compositions without the use of a crosslinking agent by diluting the uncrosslinked stock solution as defined above, in at least a single bitumen at a temperature comprised between 180° C. and 220° C., optionally with stirring, for a period of 4 hours to 48 hours.

Preferably, the method for preparing crosslinked bitumen/polymer compositions without the use of any crosslinking agent by diluting the uncrosslinked stock solution shows the duration and temperature characteristics specified above for the method for preparing crosslinked bitumen/polymer compositions without using any crosslinking agent. Preferably, the thereby obtained crosslinked bitumen/polymer composition has the characteristics defined above in terms of maximum elongation, stress at maximum elongation and conventional energy at 400% elongation. Finally, the invention relates to a crosslinked bitumen/polymer composition without any crosslinking agent, which may be obtained by the methods for diluting the crosslinked or uncrosslinked stock solution defined above.

### DETAILED DESCRIPTION

The invention relates to a method for preparing crosslinked bitumen/polymer compositions without using any crosslinking agent. By “without use of a crosslinking agent ” or “without using any crosslinking agent”, a method will be understood, in which the crosslinking agent is present as traces or impurities, the amount of crosslinking agent will therefore be lower than 0.01% by mass, with respect to the mass of the bitumen/polymer composition, preferably less than 0.001% by mass. Such traces or impurities may originate from contamination by a mixture of another kind used in the reactor, this other mixture using a crosslinking agent.

The method according to the invention applies a polymeric composition, and more specifically a polymeric composition comprising a particular copolymer. This copolymer is a diblock copolymer of a monovinylaromatic hydrocarbon block and of a conjugate diene block. By diblock copolymer of a monovinylaromatic hydrocarbon block and of a conjugate diene block, is meant a copolymer constituted by a monovinylaromatic hydrocarbon unit block and by a conjugate diene unit block, optionally comprising a hinge, in particular a random hinge on the basis of monovinylaromatic hydrocarbon units and/or conjugate diene units. The diblock copolymer of a monovinylaromatic hydrocarbon block and of a conjugate diene block according to the invention, which may be noted as “SB” is thus not contained in a triblock copolymer of a monovinylaromatic hydrocarbon block and of a conjugate diene (SBS) block and does not form either part of a branch of a star copolymer of the (SB)ₙX type.

The conjugate diene is selected among those having from 4 to 8 carbon atoms, such as butadiene (1,3-butadiene), isoprene (2-methyl-1,3-butadiene), 2,3-dimethyl-1,3-butadiene, 1,3-pentadiene, 1,3-hexadiene, 1,2-hexadiene, chloroprene, carboxylated butadiene, and carboxylated isoprene, taken alone or as a combination. Preferably, the conjugate diene is butadiene.

The monovinylaromatic hydrocarbon is selected from styrene, o-methyl styrene, p-methyl styrene, p-tert-butyl styrene, 2,3-dimethyl styrene, 2,4 dimethyl styrene, a-methyl styrene, vinyl naphthalene, vinyl toluene, and vinyl xylene, taken alone or as a combination. Preferably, the monovinylaromatic hydrocarbon is styrene. The diblock copolymer of monovinylaromatic hydrocarbon and of conjugate diene blocks is therefore preferably a diblock copolymer of styrene and of butadiene.

The diblock copolymer of a monovinylaromatic hydrocarbon block and of a conjugate diene block, according to the invention, has a molecular mass greater than or equal to 80,000 g mol⁻¹. The molecular mass of the copolymer is measured by GPC chromatography with a polystyrene standard according to the ASTM D3536 standard.

Preferably the diblock copolymer of a monovinylaromatic hydrocarbon block and of a conjugate diene block, according to the invention has a molecular mass greater than or equal to 90,000 g.mol⁻¹, more preferably greater than or equal to 100,000 g.mol⁻¹, more preferably greater than or equal to 110,000 g.mol⁻¹, more preferably greater than or equal to 120,000 g.mol⁻¹, still more preferably greater than or equal to 130,000 g.mol⁻¹. Preferably the diblock copolymer of a monovinylaromatic hydrocarbon block and of a conjugate diene block, according to the invention, has a molecular mass between 80,000 and 500,000 g.mol⁻¹, more preferably between 90,000 and 400,000 g.mol⁻¹, more preferably between 100,000 and 300,000 g.mol⁻¹, more preferably between 110,000 and 200,000 g.mol⁻¹, still more preferably between 120,000 and 150,000 g.mol⁻¹. The high mass of a diblock copolymer of a monovinylaromatic hydrocarbon block and of a conjugate diene block, according to the invention provides for maximum compatibility between the copolymer and the bitumen (the copolymer is not dissolved in the bitumen but swollen and solvated in the bitumen), provides better consistency (in particular as regards the Ring and Ball temperature)t o the bituminous crosslinked compositions, better elastic recovery and better tensile properties.

The diblock copolymer of a monovinylaromatic hydrocarbon block and of a conjugate diene block, according to the invention has a monovinylaromatic hydrocarbon amount of 20% to 50% by mass with respect to the mass of the copolymer, preferably 30% to 40%. When the diblock copolymer of a monovinylaromatic hydrocarbon block and of a conjugate diene block of the invention comprises a hinge, this hinge is preferably random and the amount of monovinylaromatic hydrocarbon in the form of a block is 15% to 30% by mass, preferably of 18% to 25% by mass with respect to the mass of the copolymer and the amount of monovinylaromatic hydrocarbon in the random hinge is 5% to 20% by mass, preferably 12% to 15% by mass with respect to the mass of the copolymer.

The diblock copolymer of a monovinylaromatic hydrocarbon block and of a conjugate diene block, according to the invention has an amount of conjugate diene 50% to 80% by mass with respect to the mass of the copolymer, preferably 60% to 70%. Among these conjugate diene units, 1-4 double bond units of conjugate diene and 1-2 double bond units of conjugate diene are distinguished. By 1-4 double bond units derived from the conjugate diene are meant the units obtained through the 1,4 addition during the polymerization of the conjugate diene. By 1-2 double bond units are meant the units obtained through the 1,2 addition during the polymerization of the conjugate diene. The result of this 1,2 addition is a vinyl double bond said to be “pending”.

The diblock copolymer of a monovinylaromatic hydrocarbon block and of a conjugate diene block, according to the invention preferably, has a content of 1-2 double bond units derived from the conjugate diene, between 15% and 30% by mass, with respect to the total mass of the conjugate diene units, more preferably between 20% and 25% by mass. Without being bound by the theory that follows, the applicant company assumes that the crosslinking observed in the method according to the invention is due to the presence of these pending vinyl double bonds in the diblock copolymer of a monovinylaromatic hydrocarbon block and of a conjugate diene block, which react at high temperature to bind the different copolymer chains together. The presence of this content of 1-2 double bond units coming from the conjugate diene is therefore essential to the method according to the invention. The content of 1-2 double bond units coming from the conjugate diene however must not be too large, and preferably must be lower than or equal to 30% by mass with respect to the mass of the conjugate diene units, to avoid excessive crosslinking of bitumen/polymer compositions, which may generate excessive rigidity of the bitumen/polymer compositions or irreversible gelling or phase separation depending on the copolymer content in the bitumen. The a content of 1-2 double bond units coming from the conjugate diene must be greater than or equal to 15% by mass, with respect to the total mass of the conjugate diene units, in order to observe crosslinking of bitumen/polymer compositions, which does not occur at lower levels

The method according to the invention applies a polymeric composition comprising a diblock copolymer of a monovinylaromatic hydrocarbon block and of a conjugate diene block as defined above. The amount of diblock copolymer of a monovinylaromatic hydrocarbon block and of a conjugate diene block in the polymeric composition is greater than or equal to 80% by mass with respect to the mass of polymeric composition, preferably greater than or equal to 85% by mass, more preferably greater than or equal to 90% by mass, more preferably greater than or equal to 95% by mass, still more preferably greater than or equal to 98% by mass. Preferably, the polymeric composition comprises only a diblock copolymer of a monovinylaromatic hydrocarbon block and of a conjugate diene block, as defined above.

The other polymers possibly present in the polymeric composition are the polymers that may be used conventionally in the field of bitumen/polymer compositions, as for example, triblock copolymers of a monovinylaromatic hydrocarbon block and of a conjugate diene block, such as styrene/butadiene/styrene SBS triblock copolymers of the monovinylaromatic hydrocarbon copolymers block and of a multibranched conjugate diene block, such as multibranched block styrene/butadiene (SB)ₙX copolymers, monovinylaromatic hydrocarbon block and “random” conjugate diene block copolymers such as styrene/butadiene rubber SBR, polybutadienes, polyisoprenes, crumb rubber derived from recycled tires, butyl rubbers, polyacrylates, polymethacrylates, polychloroprenes, polynorbornenes, polybutenes, polyisobutenes, polyolefins such as polyethylenes, polypropylenes, ethylene and vinylacetate copolymers, ethylene and methylacrylate copolymers, ethylene and butylacrylate, ethylene and maleic anhydride copolymers, ethylene and glycidyl methacrylate copolymers, ethylene and acrylate copolymers, ethylene and propylene copolymers, ethylene/propylene/diene (EP DM) terpolymers, acrylonitrile/butadiene/styrene (ABS) terpolymers, ethylene/alkylacrylate or methacrylate/glycidylacrylate or methacrylate terpolymers and notably ethylene/methylacrylate/glycidyl methacrylate and ethylene/acrylate or methacrylate alkyl/maleic anhydride and in particular ethylene/butylacrylate/maleic anhydride terpolymers.

The diblock copolymer of a monovinylaromatic hydrocarbon block and of a conjugate diene block, according to the invention is implemented in the form of powder, pellets, crushed pellets, or crumbs. The amount of polymeric composition, in particular a diblock copolymer of a monovinylaromatic hydrocarbon block and of a conjugate diene block, applied in the method, is 1% to 30% by mass with respect to the mass of bitumen/polymer composition, preferably from 2% to 20%, more preferably from 5% to 10%.

Bitumen, which may be used according to the invention, may be bitumen from different origins. Bitumen, which may be used according to the invention, may be selected from naturally occurring bitumen, such as those contained in deposits of natural bitumen, natural asphalt or tar sands. The bitumen, which may be used according to the invention may also be a mixture of bitumen or bitumen from the refining of crude oil such as straight run bitumens or reduced pressure distillation bitumens or further blown or semi-blown bitumen, propane or pentane de-asphalting residues, viscosity reduction residues, these different cuts may be taken alone or as a combination. The bitumens used may also be fluxed bitumens by adding volatile solvents, fluxes of petroleum origin in carbochemical fluxing, and/or fluxes of vegetable origin. Synthetic bitumens may also be used, also called clear bitumens, which may be pigmented or which may be dyed. The bitumen may be of a paraffinic or naphthenic origin, or a mixture of both of the bitumens. Bitumens of paraffinic origin are preferred. The applied amount of bitumen in the method is 70% to 99% by mass with respect to the mass of the bitumen/polymer compositions, preferably 80% to 98%, more preferably 85% to 90%.

In addition to the bitumen and the polymeric composition comprising the diblock copolymer of a monovinylaromatic hydrocarbon block and of a conjugate diene block, other optional ingredients commonly used in bitumens may be present. These ingredients may be waxes, resins, oils, adhesive dopes and/or acids and their derivatives.

The temperature used in the method according to the invention is a very important parameter. The method uses temperatures comprised between 180° C. and 220° C., preferably comprised between 185° C. and 215° C., more preferably comprised between 190° C. and 210° C., still more preferably comprised between 195° C. and 205° C. The applicant company noticed that these preferred temperature ranges allow crosslinking of the diblock copolymer of a monovinylaromatic hydrocarbon block and of a conjugate diene block as defined above in the bitumen while temperatures outside these preferred temperature ranges do not adequately crosslink said copolymer. In fact, lower temperatures do not allow crosslinking of said copolymer in the bitumen unless the bitumen and copolymer is left to stand for several days or even weeks. This is not desirable or feasible from a commercial and technical point of view, since a longer period of contact between the bitumen and copolymer may cause phase separations between bitumen and copolymer, degradations in the copolymer (oxidation and/or chain cuts) and bitumen oxidation. Higher temperatures, in turn, may also degrade the said copolymer (oxidation and/or chain cuts) and degrade the bitumen (oxidation). Similarly, it may sometimes be observed that the bitumen/polymer composition becomes too viscous (sometimes up to gelling), too rigid, and brittle.

The contact period between the bitumen and the polymeric composition comprising the diblock copolymer of a monovinylaromatic hydrocarbon block and of a conjugate diene block as defined above, is another important parameter, which is associated with the temperature intervals defined above. Thus, the method applies a contact between the bitumem and the polymeric composition comprising a diblock copolymer of a monovinylaromatic hydrocarbon block and of a conjugate diene block for a period of 4 hours to 48 hours, preferably from 8 hours to 30 hours, more preferably from 8 hours to 24 hours, more preferably from 10 hours to 20 hours, still more preferably from 12 hours to 16 hours. A period of less than 4 hours is sufficient to obtain optimal crosslinking and longer periods may cause the aforementioned disadvantages. The applicant company noticed that the combination of the temperature range 180° C. to 220° C. and of the time interval of 4 hours to 48 hours, allows crosslinking of the diblock copolymer of a monovinylaromatic hydrocarbon block and of a conjugate diene block in the bitumen, while temperatures and times beyond these time intervals do not allow optimal crosslinking of said copolymer.

Crosslinking of the bitumen/polymer compositions may be demonstrated by performing on the bitumen/polymer tensile tests according to standard NF EN 13587. The crosslinked bitumen/polymer compositions have a higher tensile strength than the uncrosslinked bitumen/polymer. Tensile strength is expressed as high yield elongation or high maximum elongation (max c in %), breakage stress or stress at high maximum elongation (a at max c in MPa), high conventional energy at 400% (400% E in J/cm²) and/or high total energy (total E in J).

With the method according to the invention, it is therefore possible to obtain crosslinked bitumen/polymer compositions with a maximum elongation, according to standard NF EN 13587, greater than or equal to 400%, preferably greater than or equal to 500%, more preferably greater than or equal 600%, still even more preferably greater than or equal to 700%. The method according to the invention allows therefore to obtain crosslinked bitumen/polymer compositions with a constraint on the maximum elongation, according to standard NF EN 13587, greater than or equal to 0.4 MPa, preferably greater than or equal to 0.6 MPa, more preferably greater than or equal to 0.8 MPa, still more preferably greater than or equal to 1.2 MPa. With the method according to the invention, it is therefore possible to obtain crosslinked bitumen/polymer compositions with conventional energy at 400%, according to standard NF EN 13587, greater than or equal to 3 J/cm², preferably greater than or equal to 5 J/cm², more preferably greater than or equal to 10 J/cm², still more preferably greater than or equal to 15 J/cm². With the method according to the invention, it is therefore possible to obtain crosslinked bitumen/polymer compositions with a total energy, according to standard NF EN 13587, greater than or equal to 1 J, preferably greater than or equalling 2 J, more preferably greater than or equal to 4 J, still more preferably greater than or equal to 5 J.

Other parameters may be involved in the method according to the invention. These parameters are, for example how to put the bitumen and polymeric composition in contact with each other, the shape of the reactor containing the bitumen and polymeric composition, the presence or not of air. These parameters are not critical to the method according to the invention.

Thus, the bitumen and polymeric composition are brought into contact with stirring or not. Preferably, the bitumen and polymeric composition are first brought into contact with stirring to homogenize the bitumen/polymer and stirring is stopped once the mixture is homogeneous. Where there is stirring, initial stirring is preferably vigorous and thereafter moderate. When the bitumen and polymeric composition are brought into contact with stirring, they are, for example in a reactor and when the bitumen and polymeric composition are in contact without stirring, they may be, for example in storage tanks, trucks, truck tanker etc. Preferably, the bitumen and polymeric composition are brought into contact with stirring, preferably vigorous stirring, for at least 10 minutes, preferably at least 30 minutes, more preferably at least 1 hour, more preferably at least 2 hours, more preferably at least 3 hours, still more preferably at least 4 hours, the last hours of the method being carried out without stirring or with moderate stirring.

The invention also relates to the crosslinked bitumen/polymer compositions obtained by the method according to the invention. These crosslinked bitumen/polymer compositions are characterized by a starting polymeric composition comprising at least 80% by mass of a diblock copolymer of a monovinylaromatic hydrocarbon block and of a conjugate diene block having a molecular mass greater than or equal to 80,000 g.mol⁻¹, a content of 1-2 double bond units coming from the conjugate diene greater than or equal to 15% by mass with respect to the total mass of the conjugate diene units, said copolymer being crosslinked in the bitumen matrix. The crosslinked bitumen/polymer compositions obtained by the method according to the invention are structurally different from bitumen/polymer compositions obtained from a starting polymeric composition comprising a diblock copolymer of a monovinylaromatic hydrocarbon block and of a conjugate diene block with a mass of less than or greater than 80,000 g.mol⁻¹ and a content of 1-2 double bond units coming from the conjugate diene of less than 15% by mass with respect to the total mass of the conjugate diene units. In fact, such a bitumen/polymer compositions cannot be crosslinked due to their too low content of pendant vinyl bonds. In order to crosslink bitumen/polymer compositions, a crosslinking agent based on sulphur is necessary. In this case, the copolymer chains are crosslinked, bound together by bridges containing sulphur, whereas in thermal crosslinking applied in the method according to the invention, these sulphur bridges between copolymer chains do not exist. A thermally crosslinked bitumen/polymer composition is therefore a structurally different composition from a sulphur-crosslinked bitumen/polymer composition.

In addition, the crosslinked bitumen/polymer compositions obtained by the method according to the invention are structurally different from bitumen/polymer compositions obtained from a starting polymeric composition comprising a diblock copolymer of a monovinylaromatic hydrocarbon block and of a conjugate diene block with a mass of less than 80,000 g.mol⁻¹ content and a content of 1-2 double bond units coming from the conjugate diene greater than 30% by mass with respect to the total mass of the conjugate diene units. In fact, a crosslinked bitumen/polymer composition obtained from a polymeric composition comprising a starting diblock copolymer of monovinylaromatic hydrocarbon and conjugate diene content of 1-2 double bond units coming from the conjugate diene of lower than or equal to 30% by mass with respect to the total mass of the conjugate diene units, has a three-dimensional network and physical properties different from a crosslinked bitumen/polymer composition obtained from a starting polymeric composition comprising a diblock monovinylaromatic hydrocarbon and conjugate diene copolymer also having a content of 1-2 double bond units coming from the conjugate diene higher than 30% by mass with respect to the total mass of the conjugate diene units. The presence of a larger amount of pendant vinyl bonds induces more pronounced crosslinking, a larger three-dimensional network and may stiffen the crosslinked bitumen/polymer composition too much, which may therefore become brittle or gelled. Finally, by analytical methods such as GPC chromatography, it is possible to distinguish a polymer of initial mass greater than or equal to 80,000 g.mol⁻¹, preferably greater than or equal to 90,000 g.mol⁻¹, more preferably greater than or equal to 100,000 g.mol⁻¹, more preferably greater than or equal to 110,000 g.mol⁻¹, more preferably greater than or equal to 120,000 g.mol⁻¹, still more preferably greater than or equal to 130,000 g.mol⁻¹ in a bitumen of crosslinked polymer with an initial mass of less than 80,000 g mol⁻¹, the latter also crosslinked in a bitumen.

The invention also relates to the use of a polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units from the conjugate diene greater than or equal to 15% by mass with respect to the total mass of the conjugate diene units in a bitumen for crosslinking without any crosslinking agent said bitumen/polymer composition. The bitumen, the polymeric composition, in particular the diblock copolymer of a monovinylaromatic hydrocarbon block and of a conjugate diene block, used are those described above.

The bitumen/polymer compositions obtained according to the method of the invention may be used as bituminous binders in anhydrous form or emulsion form. The bitumen/polymer compositions obtained by the method according to the invention can be used in road applications to produce hot mix asphalt, warm mix asphalt, cold mix asphalt, cold cast asphalt, asphalts, or asphalt surface coating material and/or in industrial applications for manufacturing waterproofing coating, membranes, or impregnation layers.

The invention also relates a method for preparing crosslinked bitumen/polymer compositions without the addition of a crosslinking agent, by the technique known as the “stock solution”. Instead of having the bitumen contact the polymeric composition, the polymeric composition is first brought into contact with oil and then the mixture of oil/polymeric composition is diluted by a bitumen.

This technique of the “stock solution”, allows the manufacture of highly concentrated polymer stock solutions, which are then diluted with bitumen. The bitumen, the polymeric composition, in particular the diblock copolymer of a monovinylaromatic hydrocarbon block and of a conjugate diene block, which were used, are those described above.

Two different embodiments can be considered to prepare the stock solution. In a first embodiment, the stock solution is crosslinked without the use of a crosslinking agent in oil, then diluted with bitumen. In a second embodiment, the stock solution is initially not crosslinked in oil, it is crosslinked without any crosslinking agent in a second phase when diluting with bitumen.

According to the first embodiment, to prepare the crosslinked stock solution without the use of a crosslinking agent, at least one oil, optionally at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1,2 double bond units from a conjugate diene greater than or equal to 15% by mass with respect to the total mass of the conjugate diene units, are brought into contact, optionally with stirring, at a temperature between 180° C. and 220° C. for 4 hours to 48 hours. Preferably, the temperature is maintained between 185° C. and 215° C., more preferably between 190° C. and 210° C., still more preferably between 195° C. and 205° C. Preferably, the contact period between oil, bitumen and possibly the polymeric composition is from 6 hours to 30 hours, more preferably from 8 hours to 24 hours, more preferably from 10 hours to 20 hours, still more preferably from 12 hours to 16 hours. It is understood that the above temperature ranges and the time intervals also mentioned above may be combined. The combination of these intervals of time and temperature, allows optimal crosslinking of the diblock copolymer of a monovinylaromatic hydrocarbon block and of a conjugate diene block in the oil.

According to the second embodiment, to prepare the uncrosslinked stock solution, at least one oil, optionally at least one bitumen and at least one polymeric composition comprising at least 80% by mass, with respect to the mass of the polymeric composition, a diblock copolymer of a monovinylaromatic hydrocarbon block and of a conjugate diene block having a molecular mass greater than or equal to 80,000 g mol ⁱ and content of 1-2 double bond units coming from the conjugate diene greater than or equal to 15% by mass with respect to the total mass of the conjugate diene units, are brought into contact, optionally with stirring at a temperature between 120° C. and 160° C., preferably between 130° C. and 150° C. for a period of 15 minutes to 4 hours, preferably 30 minutes to 3 hours, more preferably from 1 hour to 2 hours,. With the temperature and duration conditions used, it is not possible in this second embodiment to obtain a crosslinked stock solution.

In both embodiments, the oil used may be oil produced from petroleum or a vegetable oil or a mixture of both. The crosslinked or uncrosslinked stock solution (that is to say, obtained respectively according to the first embodiment or second embodiment) concentrated in polymer comprises, in relation to the mass of the stock solution, from 5% to 50% preferably from 10% to 40%, more preferably from 20% to 30%, of polymeric composition, in particular a diblock copolymer of a monovinylaromatic hydrocarbon block and of a conjugate diene block, as defined above.

When the crosslinked or uncrosslinked stock solution includes both oil and bitumen, the amount of oil is in majority greater with respect to the amount of bitumen. Preferably, the mass amount ratio of oil and bitumen is between 20:1 and 2:1, preferably between 10:1 and 5:1, more preferably between 8:1 and 3:1. Preferably, the crosslinked or uncrosslinked stock solution does not include bitumen.

The crosslinked or uncrosslinked stock solution may be diluted immediately, several hours after its manufacture or several days after storage thereof. The crosslinked or uncrosslinked stock solution may be stored for several days, for example from 2 to 15 days, preferably from 4 to 10 days, optionally with stirring at a temperature between 120° C. and 160° C., preferably 130° C. and 150° C. without gelling. The crosslinked or uncrosslinked stock solution is diluted with bitumen, after preparation or storage, to provide crosslinked bitumen/polymer compositions comprising from 1% to 30% by mass, preferably from 2% to 20%, more preferably from 5% to 10% of polymeric composition, in particular a diblock copolymer of a monovinylaromatic hydrocarbon block and of a conjugate diene block as defined above, with respect to the mass of the bitumen/polymer composition.

In the first embodiment, the crosslinked stock solution is diluted with bitumen to a temperature between 160° C. and 220° C., preferably between 180° C. and 200° C., optionally with stirring, for a period of 15 minutes to 4 hours, preferably 30 minutes to 3 hours, more preferably from 1 hour to 2 hours. Preferably, the crosslinked stock solution is diluted in the bitumen with stirring, preferably under vigorous stirring. In the second embodiment, the uncrosslinked stock solution is diluted with bitumen at a temperature between 180° C. and 220° C., preferably between 185° C. and 215° C., more preferably between 190° C. and 210° C., more preferably between 195° C. and 205° C., possibly with stirring for a period of 4 hours to 48 hours, preferably from 6 hours to 30 hours, more preferably from 8 hours to 24 hours, more preferably from 10 hours to 20, more preferably from 12 hours to 16 hours. Preferably, the uncrosslinked stock solution is diluted in bitumen with stirring, preferably under vigorous stirring. The crosslinked bitumen/polymer compositions via stock solution technique have tensile characteristics, as defined above, which are as good as those of the crosslinked bitumen/polymer compositions according to the method of the invention by directly involving bitumen and the polymeric composition.

### EXAMPLES

Samples of control bitumen/polymer and bitumen/polymer compositions according to the invention are prepared for evaluating and comparing their physical and mechanical characteristics. For each of the bitumen/polymer compositions prepared as described in Examples 1 to 6, the following characteristics are determined.

penetrability at 25° C. noted as P25 ( 1/10 mm) measured according to standard EN 1426

Ring and Ball temperature noted as TBA (° C.) measured according to standard EN 1427

Pfeiffer index noted as IP defined by the following formula:

$$I P = \frac{1952 - 500 \times log ( {P}_{25} ) - 20 \times T B A}{50 \times log ( {P}_{25} ) - T B A - 120}$$

elastic recovery noted as RE (%) measured at 25° C. according to standard NF EN 13398,

threshold stress noted as a threshold (MPa), stress at maximum elongation noted as a at c max (MPa), elongation threshold noted as c threshold (%), max elongation noted as c (%), conventional elongation energy at 400% noted as E 400% (J/cm²), total energy noted as Total E (D), measured according to standard NF EN 13587, the tensile test being performed at 5° C. with a stretching speed of 100 mm/minute.

The obtained results are compiled in Tables 1 to 3 below.

### Example 1

### Control

A control sample T₁ of bitumen/polymer composition is prepared wherein the bitumen/polymer composition is crosslinked with sulphur (vulcanisation). In a reactor kept at 190° C. and with stirring at 300 rpm, 94.87% by mass of a straight run distillation bitumen of paraffinic origin with 46 1/10 mm penetrability according to standard NF EN 1426 and 5% by mass of an diblock styrene/butadiene SB copolymer with random hinge having a molecular mass equal to 115,000 g.mol⁻¹, a 25% mass amount of styrene with respect to the mass of the copolymer, including 18% as a block and a 75% mass amount of butadiene with respect to the copolymer mass, are introduced, the mass amount of 1-2 double bond units from butadiene being 12% with respect to the amount by mass of butadiene. The reactor content is kept at 190° C. with stirring at 300 rpm for 4 hours. 0.13% by mass of elemental sulphur, with respect to the mass of the bitumen/polymer composition is then introduced into the reactor. The contents of the reactor is kept at 190° C. with stirring at 300 rpm for 2 hours, and then at 180° C. with stirring at 150 rpm for 12 hours.

### Example 2

### Control

A control bitumen/polymer composition sample T₂ is prepared wherein the bitumen/polymer composition is heat-treated and not crosslinked with sulphur. In a reactor kept at 190° C. and with stirring at 300 rpm, 95% by mass of bitumen of paraffinic origin with penetrability measured according to standard NF EN 1426 of 46 1/10 mm and 5% by mass of an random hinge diblock styrene/butadiene SB copolymer used in Example 1 are introduced. The contents of the reactor are then kept at 190° C. with stirring at 300 rpm for 8 hours, and then at 190° C. with stirring at 150 rpm for up to 24 hours.

TABLE 1

| | Composition T₁ | Composition T₂ |
|---|---|---|
| P₂₅ ( 1/10 mm) | 45 | 46 |
| TBA (° C.) | 62.0 | 58.6 |
| IP | 1.2 | 0.5 |
| RE (%) | 91 | 62 |
| σ threshold (MPa) | 1.3 | 1.7 |
| σ at ε max (MPa) | 0.9 | 0.2 |
| ε threshold (%) | 11.5 | 9.9 |
| ε max (%) | 700 | 180 |
| 400% E (J/cm²) | 13.4 | — |
| Total E (J) | 3.0 | 0.8 |

The bitumen/polymer composition T₁ crosslinked with sulphur has very good characteristics of consistency and very good elastomeric properties unlike the bitumen/polymer composition T₂ which is not crosslinked thermally.

### Example 3

### Aaccording to the Invention

A bitumen/polymer composition is prepared according to the invention C₃ wherein the bitumen/polymer composition is crosslinked thermally. In a reactor kept at 190° C. and with stirring at 300 rpm, 95% by mass of bitumen of paraffinic origin and with a penetrability measured according to standard EN 1426 of 46 1/10 mm and 5% by mass of a random hinge diblock styrene/butadiene SB copolymer with molecular mass of 129,000 g.mol⁻¹, an amount of styrene by mass with respect to the mass of the copolymer, of 33% including 18.9% in block form and a 66% mass amount of butadiene with respect to the mass of the copolymer, the amount of 1-2 double bond units from the butadiene is 18.5% with respect to the mass amount of butadiene are introduced. The reactor contents are then maintained at 190° C. with stirring at 300 rpm for 8 hours, then at 190° C. with stirring at 150 rpm for up to 24 hours.

### Example 4

### According to the Invention

A bitumen/polymer composition C₄ according to the invention is prepared, thermally crosslinked as in Example 3 by using 3% by mass of diblock styrene/butadiene SB copolymer with random hinge used in Example 3 and 97% by mass of the bitumen used in Example 3.

### Example 5

### According to the Invention

A bitumen/polymer composition C₅ according to the invention is prepared, thermally crosslinked by operating as described in Example 3 by using bitumen of paraffinic origin and with penetrability measured according to standard EN 1426 of 53 1/10 mm, the reactor contents being kept at 190° C. with stirring at 300 rpm for 8 hours, and then at 190° C. with stirring at 150 rpm for up to 16 hours.

### Example 6

### According to the Invention

A bitumen/polymer composition C₆ according to the invention is prepared, thermally crosslinked by operating as described in Example 3, the bitumen being a bitumen of paraffinic origin and with penetrability measured according to standard EN 1426 of 53 1/10 mm, the reactor contents being kept at 200° C. with stirring at 300 rpm for 8 hours.

TABLE 2

| | C₃ | C₄ | C₅ | C₆ |
|---|---|---|---|---|
| Reaction time (h) | 24 | 24 | 16 | 8 |
| P₂₅ ( 1/10 mm) | 35 | 43 | 48 | 47 |
| TBA (° C.) | 65.8 | 54.8 | 59.2 | 58.2 |
| IP | 1.3 | −0.4 | 0.8 | 0.5 |
| RE (%) | 81 | 66 | 75 | 72 |
| σ threshold (MPa) | 3.1 | 1.9 | 1.9 | 2.2 |
| σ at ε max (MPa) | 1.3 | 0.4 | 0.8 | 0.4 |
| ε threshold (%) | 11.7 | 10.2 | 10.6 | 10.9 |
| ε max (%) | 700 | 700 | 700 | 700 |
| 400% E (J/cm²) | 19.0 | 13.8 | 15.9 | 13.3 |
| Total E (J) | 4.1 | 2.2 | 3.1 | 1.9 |

According to the results of Table 2, the method according to the invention provides crosslinked compositions. Thus, the values of penetration, Ball and Ring temperature and elastic recovery and the values obtained in the tensile test, in particular the elongation, the stress at maximum elongation and the conventional 400% energy of compositions C₃ to C₆ are similar to those obtained for the control sample T1.

The bitumen/polymer compositions of Examples 3 to 5 are still heated to 190° C. up to 48 hours, the bitumen/polymer composition of Example 6 is further still heated to 200° C. up to 24 hours in order to observe the development of their properties. The results are in Table 3 below:

TABLE 3

| | C₃ | C₄ | C₅ | C₆ |
|---|---|---|---|---|
| Reaction time (h) | 48 | 48 | 48 | 24 |
| P₂₅ ( 1/10 mm) | 29 | 45 | 48 | 47 |
| TBA (° C.) | 72.2 | 54.8 | 59.2 | 59.2 |
| IP | 1.9 | −0.3 | 0.8 | 0.7 |
| RE (%) | 85 | 66 | 77 | 77 |
| σ threshold (MPa) | 2.9 | 2.1 | 1.9 | 1.7 |
| σ at ε max (MPa) | 1.1 | 0.7 | 1.2 | 0.9 |
| ε threshold (%) | 11.0 | 9.0 | 10.9 | 11.7 |
| ε max (%) | 700 | 700 | 700 | 700 |
| 400% E (J/cm²) | 17.2 | 16.3 | 18.6 | 15.7 |
| Total E (J) | 3.6 | 3.1 | 3.9 | 3.2 |

These results demonstrate that the properties of crosslinked bitumen/polymer compositions according to Examples 3 to 5 are stable even after 48 hours and that the properties of crosslinked bitumen/polymer composition as in Example 6 are stable even after 24 hours, the values recorded in Tables 2 and 3 being of the same order of magnitude.

1-29. (canceled)

30. A method comprising preparing crosslinked bitumen/polymer compositions without using any crosslinking agent, wherein at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹ and a content of 1-2 double bond units coming from the conjugate diene greater than or equal to 15% by mass, with respect to the total mass of the conjugate diene units, are brought into contact, at a temperature between 180° C. and 220° C., for a period of 4 hours to 48 hours.

31. The method according to claim 30, wherein the diblock copolymer has a content of 1-2 double bond units from the butadiene comprised between 15% and 30% by mass with respect to the total mass of the conjugate diene units.

32. The method according to claim 30, wherein the molecular mass of diblock copolymer is greater than or equal to 90,000 g.mol⁻¹.

33. The method according to claim 30, wherein the duration is from 6 hours to 30 hours.

34. The method according to claim 30, wherein the temperature is between 185° C. and 215° C.

35. The method according to claim 30, wherein the thereby obtained crosslinked bitumen/polymer composition has a maximum elongation, according to standard NF EN 13 587, greater than or equal to 400%.

36. The method according to claim 30, wherein the thereby obtained crosslinked bitumen/polymer composition has a stress at maximum elongation, according to standard NF EN 13 587, greater than or equal to 0.4 MPa.

37. The method according to claim 30, wherein the crosslinked bitumen/polymer composition thus obtained has a conventional energy at 400% elongation, according to standard NF EN 13 587, greater than or equal to 3 J/cm².

38. The method according to claim 30, wherein the monovinylaromatic hydrocarbon content of the diblock copolymer is comprised between 20% and 50% by mass with respect to the mass of the copolymer.

39. The method according to claim 30, wherein the diblock copolymer comprises a random hinge, the content of monovinylaromatic hydrocarbon as a block being comprised between 15% and 30% by mass with respect to the mass of the copolymer and the monovinylaromatic hydrocarbon content in the random hinge being comprised between 5 and 20% by mass with respect to the mass of the the copolymer.

40. The method according to claim 30, wherein the monovinylaromatic hydrocarbon is styrene and the conjugate diene is butadiene.

41. The method according to claim 30, wherein the polymeric composition comprises at least 85% by mass of diblock copolymer, with respect to the mass of the polymeric composition.

42. A crosslinked bitumen/polymer composition without the use of a crosslinking agent, which may be obtained by the method according to claim 30.

43. A method for preparing a crosslinked stock solution without the use of a crosslinking agent, wherein at least one oil, at least one bitumen and at least one polymeric composition, comprising at least 80% by mass with respect to the mass of the polymeric composition, of a diblock copolymer of a block of monovinylaromatic hydrocarbon and of a diene block with a molecular mass greater than or equal to 80,000 g.mol⁻¹ and a content of 1-2 double bond units coming from the conjugate diene greater than or equal to 15% by mass with respect to the total mass of the conjugate diene units, are brought into contact, at a temperature comprised between 180° C. and 220° C. for a period of 4 hours to 48 hours.

44. A method for preparing an uncrosslinked stock solution, the method comprising at least one oil, at least one bitumen and at least one polymeric composition comprising at least 80% by mass with respect to the mass of the polymeric composition, of a diblock copolymer of a monovinylaromatic hydrocarbon block and of a conjugate diene block having a molecular mass greater than or equal to 80,000 g.mol⁻¹, a content of 1-2 double bond units coming from the conjugate diene greater than or equal to 15% by mass with respect to the total mass of the conjugate diene units, are brought into contact, at a temperature comprised between 120° C. and 160° C. for 15 minutes to 4 hours.

45. A crosslinked stock solution without the use of a crosslinking agent that may be obtained by the method according to claim 43.

46. An uncrosslinked stock solution that may be obtained by the method according to claim 44.

47. The method for preparing crosslinked bitumen/polymer compositions without the use of a crosslinking agent by diluting the stock solution according to claim 45, in at least one bitumen, at a temperature comprised between 160° C. and 220° C., for a period of 15 minutes to 4 hours.

48. The method for preparing crosslinked bitumen/polymer compositions without the use of a crosslinking agent by diluting the stock solution obtained according to claim 46, in at least one bitumen, at a temperature comprised between 180° C. and 220° C., for a period of 4 hours to 48 hours.

49. A crosslinked bitumen/polymer composition without using any crosslinking agent, which may be obtained by the method according to claim 47.
